(19) United States
(12) Patent Application Publication
(10) Pub. No.: US 2018/0239790 A1
(43) Pub. Date: Aug. 23, 2018

(54) PROVISION DEVICE, PROVISION METHOD AND NON-TRANSITORY COMPUTER READABLE STORAGE MEDIUM

(71) Applicant: YAHOO JAPAN CORPORATION, Tokyo (JP)

(72) Inventors: Manabu MIYASAKA, Tokyo (JP); Masatsugu SHIDACHI, Tokyo (JP); Akira TAJIMA, Tokyo (JP)

(73) Assignee: YAHOO JAPAN CORPORATION, Tokyo (JP)

(21) Appl. No.: 15/872,604

(22) Filed: Jan. 16, 2018

(30) Foreign Application Priority Data
Feb. 21, 2017 (JP) 2017-030449

(51) Int. Cl. G06F 17/30; G06Q 30/02

(52) U.S. Cl. CPC G06F 17/30321; G06Q 30/0201; G06Q 30/0246

(57) ABSTRACT

According to one aspect of an embodiment a provision device includes an acquisition unit that acquires a context representing a leading index to lead an impression of a given context. The provision device includes a specifying unit that specifies, from distributed representations of respective contexts that are generated on the basis of a relative connection multiple contexts have, other distributed representations having a given connection with a distributed representation of the given context and a distributed representation of the context representing the leading index. The provision device includes a provision unit that provides contexts corresponding to the other distributed representations that the specifying unit specifies.

### CROSS-REFERENCE TO RELATED APPLICATIONS

The present application claims priority to and incorporates by reference the entire contents of Japanese Patent Application No. 2017-030449 filed in Japan on Feb. 21, 2017.

### BACKGROUND OF THE INVENTION

### 1. Field of the Invention

The present invention relates to a provision device, a provision method and a non-transitory computer readable storage medium.

### 2. Description of the Related Art

In recent years, with the astonishing widespread use of the Internet, information distribution via networks has been actively carried out. As an example of the information distribution, a technology of distributing information, such as advertisements or news (hereinafter, referred to as “distribution information”), about a given subject is known.

Furthermore, a method of evaluating the effect of distribution information on users has been proposed. For example, a method of evaluating to what extent distribution information has delivered information about a given subject to a user on the basis of the number of times the distribution information is browsed, the number of times the distribution information is chosen by the users, etc., is known.

Japanese Laid-open Patent Publication No. 2016-207141

Distribution of distribution information that leads a user's impression of a given subject to a given impression may be requested. For example, a demand to distribute an advertisement that leads a brand image impressing cheap products to a brand image impressing luxury products is conceivable.

The above-described conventional technology however only evaluates to what extent information about a given subject has been delivered to the user and hardly evaluates properly the effect of the distribution information on the user's impression of the given subject. As described above, with the conventional technology, it is difficult to evaluate properly a user's impression of a given subject and thus it is difficult to provide an index of distribution information that leads a user's impression of a given subject to a given impression.

### SUMMARY OF THE INVENTION

It is an object of the present invention to at least partially solve the problems in the conventional technology.

According to one aspect of an embodiment a provision device includes an acquisition unit that acquires a context representing a leading index to lead an impression of a given context. The provision device includes a specifying unit that specifies, from distributed representations of respective contexts that are generated on the basis of a relative connection multiple contexts have, other distributed representations having a given connection with a distributed representation of the given context and a distributed representation of the context representing the leading index. The provision device includes a provision unit that provides contexts corresponding to the other distributed representations that the specifying unit specifies.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an exemplary provision process that an information provision device according to an embodiment executes;

FIG. 2 is a diagram illustrating an exemplary configuration of the information provision device according to the embodiment;

FIG. 3 is a table illustrating exemplary information that is registered in a log database according to the embodiment;

FIG. 4 is a diagram illustrating exemplary information that is registered in a distributed representation space database according to the embodiment;

FIG. 5 is a diagram illustrating exemplary information that is registered in a distributed representation space database according to the embodiment;

FIG. 6 is a diagram illustrating exemplary distributed representations that the information provision device according to the embodiment specifies;

FIG. 7 is a diagram illustrating exemplary distributed representations that the information provision device according to the embodiment specifies and an order in which each distributed representation is followed;

FIG. 8 is a flowchart illustrating an exemplary flow of a provision process that the information provision device according to the embodiment executes; and

FIG. 9 is a diagram illustrating an exemplary hardware configuration.

### DETAILED DESCRIPTION OF THE PREFERRED EMBODIMENTS

With reference to the accompanying drawings, modes for carrying out the provision device, the provision method and the non-transitory computer readable storage medium according to the present application (hereinafter, referred to as “embodiments”) will be described in detail below with reference to the drawings. Note that the provision device, the provision method and the non-transitory computer readable storage medium according to the present application are not limited by the embodiments. In the following embodiments, the same components are denoted with the same reference number and redundant descriptions will be omitted.

### Embodiment

1. About Process provided by Information Provision Device

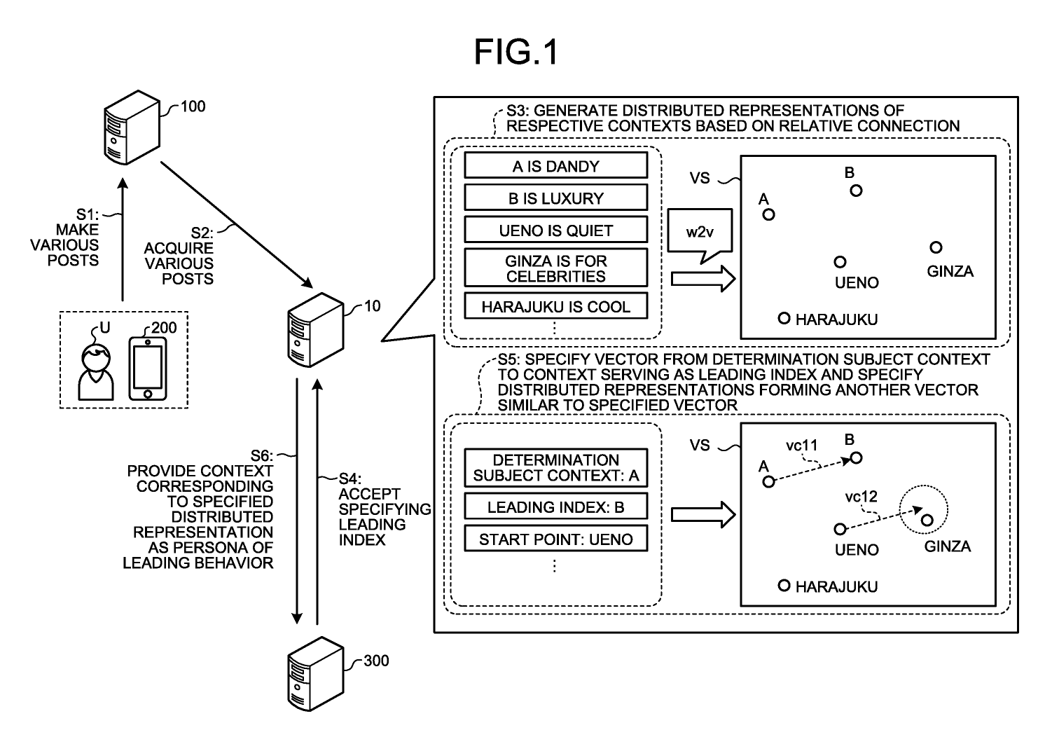

First of all, FIG. 1 will be used to describe an exemplary provision process that an information provision device serving as an exemplary provision device executes. FIG. 1 is a diagram illustrating an exemplary provision process that the information provision device according to the embodiment executes.

The following descriptions describe, as a provision process that an information provision device 10 executes, an exemplary process of providing information representing which content of distribution information should be provided when a demander requests leading a user's impression of a given subject to a given impression by using distribution information, such as an advertisement or news, about the given subject.

Any subject, such as a predetermined product, service, company, store, brand or facility, may be used as the given subject, as long as distribution information, such as an advertisement or news, about the subject delivers information to a predetermined user. The given subject may a person like an actor, an animal or various types of content, such as a movie or music. In the following descriptions, the given subject relating to the distribution information is referred to as a “determination subject”. In the following descriptions, the content relating to the determination subject, such as various types of content, including texts, images and sound, that reminds the user of various determination subjects will be referred to as a context representing the determination subject.

Any information other than advertisements and news may be used as the distribution information as long as the given information delivers information about the determination subject to the predetermined user. Advertisement is an idea including not only profitable or non-profitable advertising but also recruiting volunteers, public advertising, notification to the public, and other predetermined content. As long as the distribution information widely makes a notification of not only content containing so-called advertising-related information but also information about the predetermined subject that generates interest to the user or information contained in content relating to the predetermined subject (such as a landing page), an image, a video, texts, diagrams, symbols, hyperlinks and other any content may be contained together with texts. In the following descriptions, an exemplary provision process that is executed when an advertisement about a given brand is distributed as distribution information will be described.

1-1. Exemplary Information Provision Device

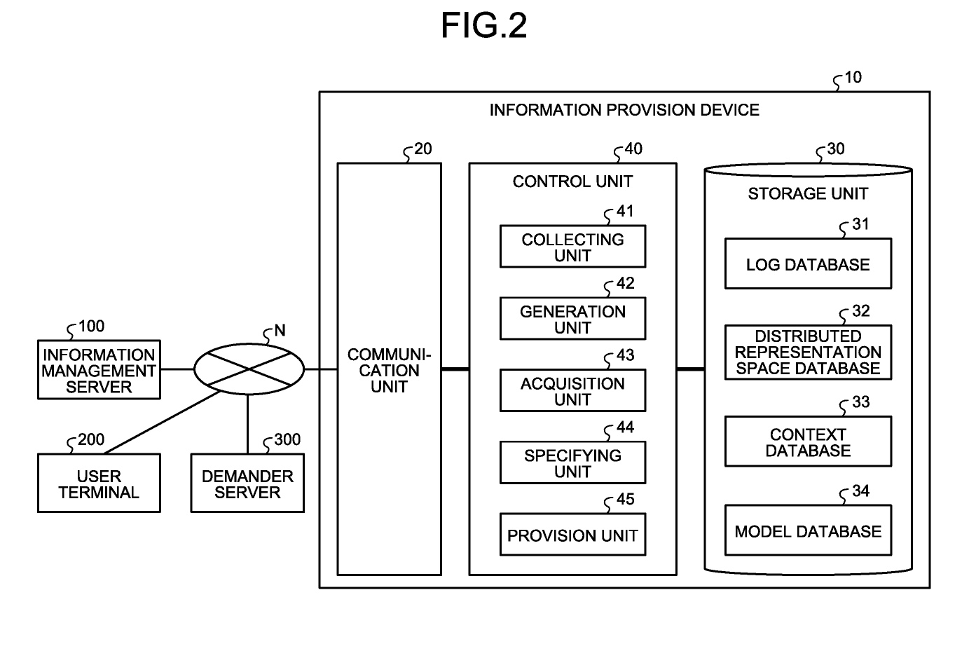

The information provision device 10 is an information processing device that is able to communicate with an information management server 100, a user terminal 200 and a demander server 300 via a given network N, such as the Internet (see, for example, FIG. 2). For example, the information provision device 10 is realized by a server device, a cloud system, or the like. The information provision device 10 may be able to communicate with a predetermined number of devices from the information management server 100, the user terminal 200 and the demander server 300.

The information management server 100 is an information processing device that provides a predetermiend web service to users and is realized by, for example, a server device or a cloud system. For example, the information management server 100 is a server device that provides various social networking services (SNS) that provide information posted by users to other users. The information management server 100 may be a server device that, on accepting posts of various types of content, such as a blog, a microblog, a web page, a message, a still image, a video and sound, disclosing the accepted content, thereby spreading various types of information about the content to the public.

The information management server 100 may be a server device that provides information about various dictionaries, news, etc., to users. The information management server 100 may be a server device that provides predetermined web services, such as portal sites, Internet auctions, electronic malls, web search, route search, map search, games, provision of real estates, provision of financial information, and services to preserve hotel facilities. The information management server 100 may be a server device that accepts evaluations by users on a predetermined subject, etc., and provides the evaluation results. The information management server 100 may be a server device that collects logs indicating the history of behaviors in the real world or on the network, such as the positional information and purchase history about a user. The information management server 100 described above manages various types of content posted by a predetermined user, the behavior history of the predetermined user, a history of searches by the predetermined user, information about a subject of electronic commerce, or the like.

The user terminal 200 is a terminal device that the predetermined user uses and that is realized by an information processing device, such as a personal computer (PC), a smart device, a mobile terminal device, a server device or a cloud system. For example, the user terminal 200 has a function of transmitting a post that the user inputs to the information management server 100, a function of displaying the information that the information management server 100 manages, and a function of delivering the content of distribution information by displaying the distribution information.

The demander server 300 is an information processing device that a demander who demands information representing the effect of the distribution information uses and that is realized by a server device, a cloud system, or the like. For example, when an advertisement about the given subject is distributed as the distribution information, the demander server 300 is used by the demander, such as an advertiser, who demands the effect of the advertisement on the user.

1-2. Exemplary Provision Process

A method of evaluating the effects of various types of information, such as advertisements and news, on users has been proposed. For example, a method of evaluating to what extent information about a subject relating to distribution information has been delivered to a user on the basis of the number of times the distribution information is browsed and the number of times the distribution information is chosen by the user, etc., has been known.

On the other hand, distribution of distribution information that leads a user's impression of a determination subject to a given impression may be requested. For example, a demand to distribute an advertisement that leads a dandy brand image to a luxury brand image is conceivable. The conventional technology however only evaluates to what extent information about the determination subject has been delivered to the user and hardly evaluates the effect of the distribution information on the user's impression of the determination subject, and thus it is difficult to provide an index representing which content of distribution information should be distributed in order to lead the user's impression.

For example, when there are Brand “A” with a dandy image and Brand “B” with a luxury image, a demand to cause the image of Brand “A” to approximate the image of Brand “B” is conceivable. Even when an advertisement similar to an advertisement of Brand “B” is distributed, however, the advertisement does not necessarily cause the image of Brand “A” to approximate the image of Brand “B”. More specifically, it is not possible to lead the image of Brand “A” unless an advertisement of content leading the image of Brand “A” to the image of Brand “B” based on the current image with respect to Brand “A” is distributed.

Thus, the information provision device 10 executes the following provision process. The information provision device 10 acquires a context representing a leading index to lead an impression of a given context. The information provision device 10 then specifies, from distributed representations of respective contexts that are generated on the basis of a relative connection multiple contexts have, other distributed representations having a given connection with a distributed representation of the given context and a distributed representation of the context representing the leading index. For example, the information provision device 10 specifies other distributed representations from distributed representations of respective contexts that are generated on the basis of a relative connection of impressions of the respective contexts that a predetermined user has. The information provision device 10 provides contexts corresponding to the specified other distributed representations.

For example, the information provision device 10 acquires various types of information that the information management server 100 manages and sets, for contexts, various types of content, such as a company name, a product name, a service name, a brand name, a facility name and a personal name. The information provision device 10 then generates a distributed representation of each of the contexts by using a technology of converting each context into a multidimensional volume on the basis of the relative connection the contexts have, such as w2v (word2vec). The information provision device 10 may employ any technology other than w2v as long as the technology converts each context into a multidimensional volume on the basis of the relative connection each context has.

For example, the information provision device 10 acquires, from the demander, a context representing one of which impression is to be led (referred to as the “determination subject context” below) and a context representing one to which the user's impression of the determination subject context is led, that is, a context representing the leading index (referred to as the “leading index context” below). In a specific example, the information provision device 10 acquires, as the determination subject context, the context of Brand “A” of which impression the user has is to be led. To lead the impression of Brand “A” to Brand “B”, the information provision device 10 acquires the context of Brand “B” as the leading index context.

The information provision device 10 specifies a vector that is from a distributed representation of the determination subject context and that leads to the leading index context as a leading content vector in a distributed representation space consisting of distributed representations of various contexts. In other words, the information provision device 10 specifies, as a leading content vector, a vector representing the content of leading the impression that the demander requests in the distributed representation space. When a vector from a given distributed representation that leads to another distributed representation is similar to the leading content vector in the distributed representation space, it is assumed that the vector represents an event similar to the content of leading the impression that the demander requests. The information provision device 10 thus specifies a vector similar to the leading content vector from the distributed representation space and specifies contexts corresponding to the distributed representations forming the specified vector. The information provision device 10 outputs the specified context.

A specific example of a process executed by the information provision device 10 will be described below. For example, there are distributed representations of contexts of Brand “A”, Brand “B”, Area “Ueno” and Area “Ginza” in a distributed representation space. Furthermore, a vector from Brand “A” leading to Brand “B” and a vector from Area “Ueno” leading to Area “Ginza” are similar to each other.

In that case, it is assumed that the impression of Brand “A” corresponds to the impression of Area “Ueno” and the impression of Brand “B” corresponds to the impression of Area “Ginza and, at the same time, the distribution information that causes the impression of Brand “A” to approximate the impression of Brand “B” corresponds to the distribution information that causes the impression of Area “Ueno” to approximate the impression of Area “Ginza”. Thus, in the case where the demander wants the impression of Brand “A” to approximate the impression of Brand “B”, the information representing the vector from Area “Ueno” leading to Area “Ginza” in the distributed representation space may serve as an index when the demander generates or distributes distribution information. For example, it is also assumed that it is possible to cause the impression of Brand “A” to approximate the impression of Brand “B” by distributing the distribution information to a user associated with Area “Ginza” instead of the user associated with Area “Ueno”.

The information provision device thus provides contexts corresponding to the distributed representations forming the vector similar to the leading content vector, that is, the contexts of Area “Ueno” and Area “Ginza”. For example, the information provision device 10 outputs the contexts corresponding to the distributed representations forming the vector similar to the leading content vector and information indicating whether each context is the start point or the end point of the vector or information corresponding to the information on whether each context is the start point or the end point in a form, such as, “Change the target from Ueno to Ginza”. As a result, the information provision device 10 is able to provide an index representing which distribution information should be generated or distributed for the demander to lead the user's impression.

1-3. About Generation of Distributed Representation

A process of generating a distributed representation of each context will be described. For example, the information provision device 10 collects other predetermined information, such as content posted by users, the histories of search queries, news, dictionaries and behavior information about users, from a predetermined server device, such as the information management server 100, on the network. In the following descriptions, various types of information the information provision device 10 collects in order to generate distributed representations may be referred to as “logs”. Subsequently, the information provision device 10 extracts a predetermined context from the logs by executing a process, such as morphological analysis. The context is not limited to a context representing a determination subject.

On the basis of frequency of appearance of other words appearing together with each context, the information provision device 10 carries out learning by a learner that generates a distributed representation from a context such that distributed representations of contexts similar to each other are similar to each other and and distributed representations of contexts not similar to each other are not similar to each other. In other words, the information provision device 10 generates a learner that performs vectorization of each context (that is, conversion into a distributed representation) on the basis of the relative connection the contexts have. The information provision device 10 then generates a distributed representation of each context by using the generated learner. In the following descriptions, a set of the distributed representations of the respective contexts may be referred to as the “distributed representation space”.

The information posted by the predetermined user may contain words representing the user's impression of the determination subject, such as “A is dandy” or “B is luxury”. When a distributed representation space of contexts is generated from such information, it is assumed that the user's impression of the determination subject is reflected in the distributed representation of each determination subject context. More specifically, with respect to multiple determination subjects of which impressions the user has are luxury, distributed representations similar to one another are generated from the corresponding contexts.

The information posted by the predetermined user may contain contexts representing different types of determination subjects, for example, contexts representing areas, such as “Ueno” and “Ginza”, and contexts representing brands, such as “A” and “B”. It is assumed that the contexts representing different types of determination subjects are highly likely to appear together with other words corresponding to the types. For example, when a context represents an area, the context is highly likely to appear together with a word relating to the area and, when a context represents a brand, the context is highly likely to appear together with a word relating to the brand. For this reason, it is assumed that, when a distributed representation space of the contexts is generated, distributed representations having relatively high similarity are generated from the same type of and distributed representations having relatively low similarity are generated from differ types of contexts.

Thus, the information provision device 10 generates a distributed representation of each context from the information posted by the user, etc., by using a technology of converting each context into a multidimensional volume on the basis of the relative connection each context has. As a result, the information provision device 10 is able to generate a distributed representation of each context on the basis of the relative connection of the determination subjects corresponding to the respective contexts and of the relative connection of the impressions of the determination subjects corresponding to the respective contexts the predetermined user has.

The information provision device 10 may generate a distributed representation space of contexts on the basis of predetermined information as long as the predetermined information may contain information representing the user's impression of each determination subject, such as the content posted by the predetermined user, the history of behaviors of the predetermined user, the search history of the predetermined user or information about the subject of electronic commerce.

Furthermore, the information provision device 10 need not reflect the user's impression of a determination subject on the basis of the adjectives contained in the same post, the same sentence, or the like. In other words, the information provision device 10 may estimate the impression of the determination subject relating to the post that User U has on the basis of not only the information posted by User U but also, for example, the biological information or the content of behavior at the time when User U makes the post and may generate the distributed representation reflecting the estimated impression. Alternatively, the impression of the determination subject that User U has may be estimated on the basis of whether User U frequently visits a shop or site relating to the determination subject and a distributed representation reflecting the estimated impression may be generated. In other words, the information provision device 10 may generate a distributed representation by using any method from any information as long as it is possible to reflect the relative impression of the determination subject that User U has in the distributed representation.

1-4. About Exemplary Provision Process

An exemplary provision process that the information provision device 10 executes will be described. The following example describes an exemplary process of providing information representing distribution information that causes the user's impression of Brand “A” to the user's impression of Brand “B” to the demander who requests the distribution information (that is, a persona of a leading behavior). In the following descriptions, “User U” does not refer to a specific user but refers to many and unspecified users.

For example, User U posts various types of information to the information management server 100 (step S1). For example, the user U posts information containing contexts representing brand names and area names, for example, “A is dandy”, “B is luxury”, “Ueno is quiet”, “Ginza is for celebrities” and “Harajuku is cool”. In such a case, the information provision device 10 acquires various posts (step S2). The information provision device 10 then generates distributed representations based on the relative connections of the contexts from the acquired various posts (step S3).

For example, the information provision device 10 extracts contexts “A” and “B” that are contexts representing various brands and “Ueno”, “Ginza” and “Harajuku” representing areas from the various types of information posted by User U by using an analysis technology, such as morphological analysis. The information provision device 10 then converts the respective contexts into distributed representations by using w2v such that the type of the determination subject that each context represents and the relative connection of the impressions that the user has are reflected. For example, the information provision device 10 generates the distributed representations of the respective contexts such that the distributed representations of “A” and “B” representing brands are similar to each other and the distributed representations of “Ueno”, “Ginza” and “Harajuku” are similar to one another. Furthermore, for example, the information provision device 10 generates distributed representations such that distributed representations of contexts on which the user has similar impressions (for example, “B” and “Ginza”) are similar to each other and generates a distributed representation space VS containing the generated distributed representations.

The information provision device 10 then accepts specifying a leading index from the demander (step S4). For example, the information provision device 10 accepts specifying a determination subject context “A” and a leading index context “B” from the demander. Furthermore, in order to facilitate searching for a vector similar to a leading content vector, that is, a vector consisting of the distributed representations of contexts to be provided (the “provision vector” below), the information provision device 10 accepts specifying the context “Ueno” corresponding to the distributed representation serving as the start point of the provision vector.

In that case, the information provision device 10 specifies a vector from the determination subject context to the context serving as the leading index in the distributed representation space and specifies distributed representations forming another vector similar to the specified vector (step S5). In other words, the information provision device 10 specifies the vector that is from the distributed representation of the determination subject context and that leads to the distributed representation of the leading index context as the leading content vector. The information provision device 10 then specifies, as other distributed representations, the distributed representations forming the another vector similar to the leading content vector. More specifically, the information provision device 10 specifies distributed representations forming a vector that is the another vector similar to the leading content vector and whose start point is a distributed representation of a context that is specified as the start point in advance.

For example, by subtracting the distributed representation of the determination subject context “A” from the distributed representation of the leading index context “B” in the distributed representation space, the information provision device 10 calculates a leading content vector vc11 that is from the distributed representation of the determination subject context “A” and that leads to the distributed representation of the leading index context “B”. The information provision device 10 then calculates the sum of the distributed representation of the context “Ueno” specified as the start point and the leading content vector vc11 and specifies another distributed representation similar to the calculated sum. For example, in the example illustrated in FIG. 1, the information provision device 10 calculates a vector vc12 whose start point is the distributed representation of the context “Ueno” and whose orientation and norm are the same as those of the leading content vector vc11. The information provision device 10 then specifies the distributed representation of the context “Ginza” as the distributed representation the most approximate to the end point of the calculated vector vc12. As a result, the information provision device 10 specifies, as the provision vector, the vector whose start point is the distributed representation of the context “Ueno” and whose end point is the distributed representation of the context “Ginza”.

The information provision device 10 provides the context corresponding to the specified distributed representation, that is, the context “Ginza” to the demander as a persona of the leading behavior (step S6). As a result, for example, the demander is able to specify that the behavior of leading the impression of Brand “A” to the impression of “Brand” B is similar to the behavior of leading the impression of Area “Ueno” to the impression of “Ginza”.

For example, the demander may perform an advertisement campaign in Area “Ginza” without performing the advertisement campaign in Area “Ueno” and may distribute an advertisement to users associated with Area “Ginza” without distributing the advertisement to users associated with Area “Ueno”. The demander may generate, as distribution information, an advertisement that causes the image of Area “Ueno” to approximate the image of Area “Ginza”. In other words, the information provision device 10 is able to provide information representing the behavior of leading the impression requested by the demander from another aspect, that is, the persona of the leading behavior and thus is able to provide information indicating the content of the distribution information to realize leading the impression requested by the demander and the mode of distribution of distribution information (that is, the index).

2. About Variation of Provision Process

An exemplary provision process performed by the information provision device 10 has been described; however, the embodiments are not limited thereto. Variations of the provision process executed by the information provision device 10 will be described below.

2-1. About Searching for Provision Vector

In the above-described example, the information provision device 10 accepts specifying the context serving as the start point of the provision vector from the demander. In such a case, the information provision device 10 is able to provide an index enabling the demander to have an image easily as the index requested by the demander when generating or distributing distribution information. For example, the information provision device 10 is able to provide information representing to which behavior based on Area “Ueno” the demander's behavior of leading the impression of Brand “A” to the impression of Brand “B” corresponds; however, the embodiments are not limited thereto.

For example, on accepting specifying a context serving as the end point of the provision vector, the information provision device 10 may specify, as the provision vector, a vector that is similar to the leading content vector and whose end point is the distributed representation of the context specified as the end point and may provide a distributed representation similar to the start point of the specified provision vector. In a more specific example, on accepting Area “Ginza” as the end point of the provision vector, the information provision device 10 may generate a multidimensional volume obtained by subtracting the leading content vector vc11 from the distributed representation of Area “Ginza” and specify a distributed representation similar to the generated multidimensional volume (for example, the distribution representation of Area “Ueno”). The process enables the information provision device 10 to, when Brand “B” to which the impression is led is used as Area “Ginza”, provide information indicating as which context Brand “A” of which impression is led can be regarded.

In the above-described process, the information provision device 10 accepts specifying the start point or the end point of the provision vector and thus is able to reduce the amount of searching for the provision vector similar to the leading content vector in the distributed representation space; however, the embodiments are not limited thereto. For example, the information provision device 10 may search vectors formed by distributed representations in a distributed representation space for a vector similar to a leading content vector and provide contexts corresponding to distributed representations forming the searched vector. By executing that process, the information provision device 10 is able to provide regarding that the demander has never imagined with respect to the content of leading.

Furthermore, the information provision device 10 may specify distributed representations forming a provision vector from distribution representations that belong to a given category. For example, in the case where the demander requests information representing which content will be when the the leading content of leading the impression of Brand “A” to the impression of Brand “B” is regarded as areas, the information provision device 10 specifies distributed representations of contexts relating to the areas and searches vectors formed by the specified distributed representations for a vector similar to the leading content vector. The information provision device 10 may specify the distributed representations forming the vector that is searched for and provide the contexts corresponding to the specified distributed representations to the demander.

Distributed representations of various types of contexts are contained in the distributed representation space VS. There is therefore a risk that the start point and the end point of the provision vector may be distributed reorientations of different types of contexts. As described above, when the start point and the end point of the provision vector are distributed representations of different types of contexts, it may be hard for the demander to image the leading content properly. Thus, the information provision device 10 may search for a provision vector such that the start point and the end point are distributed representations of the same type of contexts.

For example, the information provision device 10 calculates a multidimensional volume obtained by adding the provision vector to the distributed representation of the context serving as the start point. The information provision device 10 may specify a distributed representation similar to the calculated multidimensional volume among distributed representations of contexts that belong to the same category as that of the context serving as the start point and may provide the context corresponding to the specified distributed representation to the demander.

2-2. About Provision of Relay Point

The information provision device 10 may provide information indicating a relay point of the leading behavior. For example, the information provision device 10 specifies a vector similar to the leading content vector as the provision vector. In that case, the information provision device 10 further specifies a distributed representation that is positioned in the vicinity of the provision vector. The information provision device 10 may provide a context corresponding to the distributed representation that is positioned in the vicinity of the provision vector as an index to lead the impression of the determination subject context by stages.

More specifically, the information provision device 10 specifies a given number of distributed representations from among distributed representations positioned in the vicinity of the provision vector and specifies an order in which the specified distributed representations are followed such that the impression approximates the distributed representation serving as the end point of the provision vector by stages from the distributed representation serving as the start point of the provision vector. The information provision device 10 may provide information representing the contexts corresponding to the respective specified distributed representations and the order in which the distributed representations corresponding to the respective contexts are followed.

For example, the information provision device 10 specifies the vector that is from the distributed representation of Area “Ueno” and that leads to the distributed representation of Area “Ginza” as the provision vector similar to the leading content vector that is from the distributed representation of Brand “A” and that leads to the distributed representation of Brand “B”. The information provision device 10 further searches for other distributed representations positioned in the vicinity of the specified provision vector by using a predetermined vector search technology and, for example, specifies a distributed representation of Area “Shinagawa” and a distributed representation of Area “Yurakucho”.

In that case, the information provision device 10 calculates similarity (for example, a Euclidean distance or cosine distance) of the distributed representation of Area “Ueno” with the distributed representation of Area “Shinagawa” and the distributed representation of Area “Yurakucho”. The information provision device 10 determines, as the order in which the specified distributed representations are followed, to follow the distributed representations according to the descending order of the similarity to the distributed representation of Area “Ueno”. For example, when the similarity of the distributed representation of Area “Shinagawa” to the distributed representation of Area “Ueno” is higher than that of Area “Yurakucho”, the information provision device 10 specifies an order starting from the distributed representation of Area “Ueno” in which the distributed representation of Area “Shinagawa” is followed at first, the distributed representation of Area “Yurakucho” is followed, and then the distributed representation of Area “Ginza” is reached.

The information provision device 10 outputs the contexts of the respective areas and the order in which the distributed representations corresponding to the contexts of the respective areas are followed. As a result, the information provision device 10 is able to provide an index to lead the impression of the determination subject context by stages.

The information provision device 10 may take various types of weighting in order to properly choose the order in which each distributed representation is followed and the distributed representations to be followed into consideration. For example, the information provision device 10 may specify a given number of distributed representations from among the distributed representations positioned in the vicinity of the provision vector such that the inner product of the route in which each distributed representation is followed and the provision vector is within a given range. Executing that process makes it possible to prevent the phenomenon that the meaning of the context corresponding to the relay point deviates suddenly.

2-3. About Impression of User

In the above-described example, the information provision device 10 reflects the user's impression of a determination subject in a distributed representation by converting a determination subject context into the distributed representation. The process is a process for reflecting the impression of the determination subject and, at the same time, is a process for reflecting the impression of the determination subject context. In other words, the user's impression to be reflected in the distributed representation is not only the impression of the determination subject but also an idea containing the impression of the context representing the determination subject.

For example, when there are multiple texts representing the same brand but in different fonts, the information provision device 10 may deal with the texts as individual contexts or as the same context. By executing such a process, the information provision device 10 may reflect the impression of the brand (that is, a determination subject) in a distributed representation or reflect the impression of each context representing the brand in the distributed representation.

2-4. About Generation of Distributed Representation Space

The information provision device 10 may perform predetermined weighting when generating a distributed representation space. For example, the information provision device 10 may generate distributed representations such that the similarity of distributed representations of different types of contexts is equal to or larger than a given threshold. The information provision device 10 may convert a context serving as a guide (anchor) in a distributed representation space (hereinafter, referred to as “anchor”) into a distributed representation. For example, the information provision device 10 extracts a given adjective, such as “high” or “dandy”, as an anchor from posts. The information provision device then generates distributed representations of the determination subject context and the anchor.

When such a distributed representation space is generated, the anchor serves as one index on what kind of impression of the determination subject the user has. By providing information representing the distributed representation space containing the anchor, the information provision device 10 may provide information representing which content the leading content vector or the provision vector represents with respect to the anchor.

2-5. About Mode of Application

The information provision device 10 may execute any process other than the above-described process as long as it is possible to represent the leading content requested by the demander with contexts different from the contexts forming the leading content vector. The information provision device 10 may output the contexts forming the provision vector in any mode.

The information that is provided by the information provision device 10 may be used by the demander in any mode. For example, the contexts corresponding to the distributed representations serving as the start point and the end point of the provision vector may be used to select users to which distribution information, such as an advertisement, is distributed or select users targeted by marketing. In other words, the information provided by the information provision device 10 is information representing the leading content requested by the demander from another side and is information on which predetermined interpretation is performed by the demander.

3. Configuration of Information Provision Device

An exemplary functional configuration the above-described information provision device 10 will be described below. FIG. 2 is a diagram illustrating an exemplary configuration of the information provision device according to the embodiment. As illustrated in FIG. 2, the information provision device 10 includes a communication unit 20, a storage unit 30 and a control unit 40.

The communication unit 20 is realized by, for example, a network interface card (NIC), or the like. The communication unit 20 is connected to a network N in a wired or wireless manner and transmits and receives information to and from the information management server 100, the user terminal 200 and the demander server 300.

The storage unit 30 is realized by, for example, a semiconductor memory device, such as a random access memory (RAM) or a flash memory, or a storage device, such as a hard disk or an optical disk. The storage unit 30 stores a log database 31, a distributed representation space database 32, a context database 33, and a model database 34.

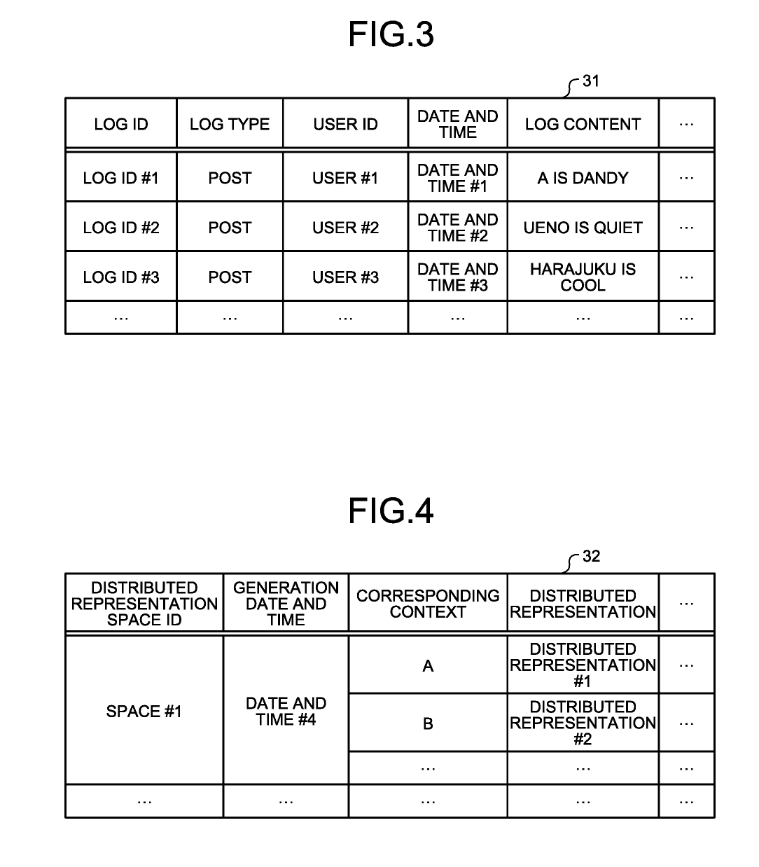

Various posts used to generate distributed representations are registered in the log database 31. For example, FIG. 3 is a diagram illustrating exemplary information that is registered in the log database according to the embodiment. In the example illustrated in FIG. 3, information, such as a “log identifier (ID)”, a “log type”, a “user ID”, a “date and time” and “log content”, is registered in the log database 31.

A “log ID” is an identifier that identifies a log. A “log type” is information indicating whether the log indicated by the “log ID” associated with the “log type” is, for example, a SNS post or a search query. A “user ID” is an identifier of a user having a connection with the log indicated by the “log ID” associated with the “user ID”. A “date and time” indicates a date and time on which the log indicated by the “log ID” associated with the “date and time” is posted on the network. Furthermore, “log content” refers to various types of content collected as logs.

For example, in the example illustrated in FIG. 3, sets of information, such as a log ID “LOG ID #1”, a log type “POST”, a user ID “USER #1”, a date and time “DATE AND TIME #1” and log content “A IS DANDY”, are registered in association with one another in the log database 31. The information indicates that the log content “A IS DANDY” is registered by the user indicated by the user ID “USER #1” as the log indicated by the log ID “LOG ID #1” and as the content posted at the date and time indicated by the date and time “DATE AND TIME #1”.

The example illustrated in FIG. 3 represents conceptual values including “LOGID #1”, “USER #1” and “DATE AND TIME #1”; however, character strings identifying logs and users and character strings representing dates and times are registered practically in the log database 31. In the log database 31, any information may be registered in addition to the information illustrated in FIG. 3 as long as the information relates to various types of information to be collected as logs. The example illustrated in FIG. 3 represents the example where content posted by the user and an input search query are registered as log types; however, practically, various types of content, such as news, dictionaries and web pages, and information indicating the type of each set of content are registered in the log database 31.

FIG. 2 will be referred back and the description will be continued. In the distributed representation space database 32, generated distributed representation spaces are stored. For example, FIG. 4 is a diagram illustrating exemplary information that is registered in the distributed representation space database according to the embodiment. In the example illustrated in FIG. 4, sets of information, such as a “distributed representation space ID”, a “generation date and time”, a “corresponding context” and a “distributed representation”, are registered in association with one another in the distributed representation space database 32. Any information may be registered in addition to the information illustrated in FIG. 4 in the distributed representation space database 32 as long as, for example, the information relates to the distributed representation.

A “distributed representation space ID” is an identifier that identifies a distributed representation space. A “generation date and time” is information representing a date and time on which a distributed representation space indicated by a “distributed representation space ID” associated with the “generation date and time” is generated, that is, a date and time on which the distributed representation contained in the distributed representation space represented by the associated “distributed representation space ID” is generated. A “corresponding context” is information representing a context from which the distributed representation originates. A “distributed representation” is a distributed representation of a “corresponding context” associated with the “distributed representation”.

For example, in the distributed representation space database 32, sets of information including a distributed representation space ID “SPACE #1”, a generation date and time “DATE AND TIME #4”, a corresponding context “A” and a distributed representation “DISTRIBUTED REPRESENTATION #1” are registered in association with one another. The information indicates that the distributed representation of the corresponding text “A” that is generated on the date and time indicated by the generation date and time “DATE AND TIME #4” is the distributed representation “DISTRIBUTED REPRESENTATION #1” as the distributed representation contained in the distributed representation space indicated by the distributed representation ID “SPACE #1”.

The example illustrated in FIG. 4 represents conceptual values, such as “SPACE ID #1”, “DATE AND TIME #1” AND “A”; however, practically, character strings indicating distributed representation spaces and dates and times and content, such as texts and images serving as contexts, are registered in the distributed representation space database 32.

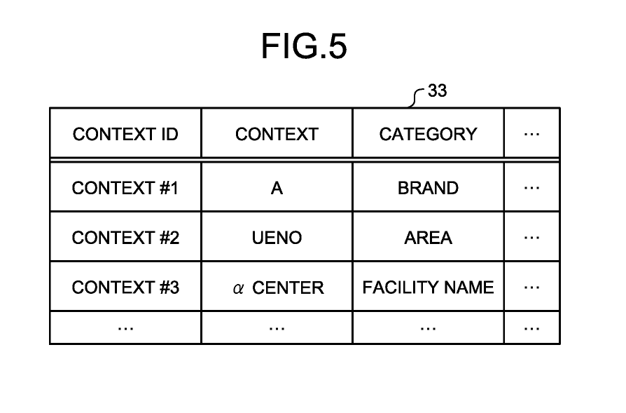

FIG. 2 will be referred back and the description will be continued. In the context database 33, information about various contexts from which distributed representations are generated is registered. For example, FIG. 5 is a diagram illustrating exemplary information that is registered in the context database according to the embodiment. In the example illustrated in FIG. 5, sets of information, such as a “context D”, a “context” and a “category” are registered in association with one another in the context database 33. In the context database 33, any information may be registered in addition to the information illustrated in FIG. 5 in the context database 33 as long as the information relates to a context.

A “context ID” is an identifier that identifies a context. A “context” is a context extracted from various posts. A “category” is information representing the type of the context associated with the “category”, that is, information representing the category of the determination subject represented by the context. For example, in the example illustrated in FIG. 5, the context ID “CONTEXT #1”, the context “A”, and the category “BRAND” are registered in association with one another. The information represents that the context represented by the context ID “CONTEXT #1” is the context “A” and the type of the determination subject represented by the context “A” is the category “BRAND”.

The example illustrated in FIG. 5 represents conceptual values including “CONTEXT #1”; however, character strings representing contexts are registered in the context database 33 practically. Any setting may be made for the content and type of contexts in addition to the contexts and types illustrated in FIG. 5.

FIG. 2 will be referred back and the description will be continued. In the model database 34, a model for converting a context into distributed representation is registered. For example, a leaner that classifies each context according to similarity of each context and regards the similarity between user's impressions of contexts (or determination subjects indicated by the contexts) contained in logs as an element to classify each context is registered as a model in the model database 34. Such a model is realized by, for example, a learner that classifies each context on the basis of the rate at which another word class, such as an adjective, appearing with a context or similarity thereof. For example, the model may be realized by a multi-stage neural network, such as convolutional neural networks (CNN), or may be realized by, for example, a classifier, such as a support vector machine (SVM), as long as the above-described functions are realized.

The control unit 40 is a controller and is realized by, for example, a processor, such as a central processing unit (CPU) or a micro processing unit (MPU), by executing various programs sored in a storage device in the information provision device 10 in a RAM, or the like, serving as a work area. The control unit 40 is a controller and, for example, the control unit 40 may be realized by an integrated circuit, such as an application specific integrated circuit (ASIC) or a field programmable gate array (FPGA). The control unit 40 serves as an arithmetic processing device that reads indices.

As illustrated in FIG. 2, the control unit 40 includes a collecting unit 41, a generation unit 42, an acquisition unit 43, an specifying unit 44 and a provision unit 45. The collecting unit 41 collects various logs from the predetermined information management server 100. For example, the collecting unit 41 collects various logs, such as sets of content posted by the user, the history of behaviors of the user, the history of search queries of the user, and information including evaluation on a subject of electronic commerce and web pages of electronic commerce, and registered the collected logs in the log database 31.

The generation unit 42 generates a distributed representation of each context on the basis of the relative connection that multiple contexts have. More specifically, the generation unit 42 generates vectors indicating the respective contexts as distributed representations by using the model to convert each context into a vector on the basis of the relative connection that the multiple contexts have.

For example, the generation unit 42 extracts various logs from among the various types of information that are registered as logs in the log database 31 and extracts contexts from the extracted logs. By using the model that is registered in the model database 34, the generation unit 42 converts the contexts into distributed representations on the basis of the similarity of the extracted contexts. The generation unit 42 then registers a date and time on which a distributed representation is generated and a distributed representation space ID in association with a set of a generated distributed representation and a context from which the distributed representation originates in the distributed representation space database 32.

The generation unit 42 may generate distributed representations from all the logs registered in the log database 31 at given time intervals and register the generated distributed representations as distributed representation spaces different according to the respective sets of timings at which the distributed representations are generated in the distributed representation space database 32. Furthermore, the generation unit 42, for example, may generate multiple distributed representations from the logs of posts, or the like, made within a day from the date and time on which a distributed representation is generated and may register the generated multiple distributed representations as a distributed representation space in the distributed representation space database 32. In other words, the generation unit 42 may generate a distributed representation space reflecting user's impressions within a given period with respect to each period.

The acquisition unit 43 acquires a context representing a leading index to lead an impression of a given context. More specifically, the acquisition unit 43 acquires a context to which the impression of the given context is to be led as the context representing the leading index.

For example, the acquisition unit 43 acquires a context of a determination subject of which impression the user has is to be led, that is, the context “A” of Brand “A”, as a determination subject context from the demander server 300. The acquisition unit 43 acquires a context of a determination subject to which the user's impression is to be led, that is, the context “B” of Brand “B” as a leading index context.

The acquisition unit 43 may accept specifying contexts corresponding to the start point and the end point of a provision vector in addition to the determination subject context and the leading index context. For example, the acquisition unit 43 may accept specifying the context “Ueno” as a context of a distributed representation serving as the start point of the provision vector and accept specifying the context “Ginza” as a context of a distributed representation serving as the end point of the provision vector. The acquisition unit 43 may accept specifying a type of contexts corresponding to the distributed representations forming the provision vector.

The specifying unit 44 specifies, from distributed representations of respective contexts that are generated on the basis of a relative connection multiple contexts have, other distributed representations having a given connection with a distributed representation of a given context and a distributed representation of a context representing a leading index. For example, the specifying unit 44 specifies a vector that is from the distributed representation of the given context and that leads to the distributed representation of the context representing the leading index and specifies distributed representations forming another vector similar to the specified vector. The specifying unit 44 specifies other distributed representation from the distributed representations of the respective contexts that are generated on the basis of the relative connection of the impressions of the respective contexts the predetermined user has.

In other words, the specifying unit 44 specifies, from the distributed representations in the distributed representation space, other distributed representations having the given connection with the distributed representation of the determination subject context and the distributed representation of the leading index context. For example, the specifying unit 44 calculates a leading content vector that is from the distributed representation of the determination subject context and that leads to the distributed representation of the leading index context and specifies a provision vector similar to the calculated leading content vector. The specifying unit 44 then specifies distributed representations forming the specified leading vector.

The specifying unit 44 may specify, as other distributed representations, the distributed representations forming the provision vector that is similar to the leading content vector and whose start point is a distributed representation of a context that is specified in advance. Specifically, the specifying unit 44 may calculate the sum of the distributed representation of the context that is specified in advance and the leading content vector and specify another distributed representation similar to the calculated sum.

For example, the specifying unit 44 acquires the distributed representations of the determination subject context “A” and the leading index context “B” from the distributed representation space database 32. The specifying unit 44 calculates the leading content vector by subtracting the distributed representation of the determination subject context “A” from the distributed representation of the leading index context “B”. The specifying unit 44 then specifies the distributed representation of the context “Ueno” that is specified as the start point of the provision vector from the distributed representation space database 32. The specifying unit 44 calculates the sum of the specified distributed representation of the context “Ueno” and the leading content vector and searches the distributed representation space database 32 for another distributed representation similar to the calculated sum, that is, the distributed representation serving as the end point of the provision vector similar to the leading content vector.

The specifying unit 44 may specify, as other distributed representations, the distributed representations forming the provision vector that is similar to the leading content vector and whose end point is a distributed representation of a context that is specified in advance. Specifically, the specifying unit 44 may calculate a multidimensional volume obtained by subtracting the leading content vector from the distributed representation of the context that is specified in advance and specify a distributed representation similar to the calculated multidimensional volume.

For example, the specifying unit 44 calculates the leading content vector by subtracting the distributed representation of the determination subject context “A” from the distributed representation of the leading index context “B”. The specifying unit 44 then specifies the distributed representation of the context “Ginza” that is specified as the end point of the provision vector from the distributed representation space database 32. The specifying unit 44 calculates a multidimensional volume obtained by subtracting the leading content vector from the specified distributed representation of the context “Ginza” and searches the distributed representation space database 32 for another distributed representation similar to the calculated multidimensional volume, that is, the distributed representation serving as the start point of the provision vector similar to the leading content vector.

The specifying unit 44 may specify, as the end point and the start point of the provision vector, distributed representations of contexts that belong to the same category as the category to which the contexts that are specified in advance as the start point and the end point of the provision vector. For example, when the context “Ueno” is chosen as the start point, the specifying unit 44 refers to the context database 33 and specifies the category “Area” to which the context “Ueno” belongs. In that case, the specifying unit 44 specifies contexts associated with the category “Area” and extracts distributed representations of the specified contexts from the distributed representation space database 32. The specifying unit 44 may calculate a multidimensional volume obtained by adding the leading content vector to the distributed representation of the context “Ueno” and specify a distributed representation similar to the calculated multidimensional volume from among the distributed representations extracted from the distributed representation space database 32.

The specifying unit 44 need not accept specifying the start point and the end point of the provision vector. For example, the specifying unit 44 may calculate all vectors formed by the distributed representations in the distributed representation space, specify a vector similar to the leading content vector from among the calculated vectors (for example, a vector with a difference in the cosine similarity or norm is within a given range), and specify distributed representations serving as the start point and the end point of the specified vector.

The specifying unit 44 may specify distributed representations forming another vector from distributed representations of contexts that belong to a given category. For example, the specifying unit 44 may specify distributed representations of contexts that belong to a category chosen by the demander, calculate all vectors formed by the specified distributed representations, specify a vector similar to the leading content vector from among the calculated vectors, and specify distributed representations serving as the start point and the end point of the specified vector.

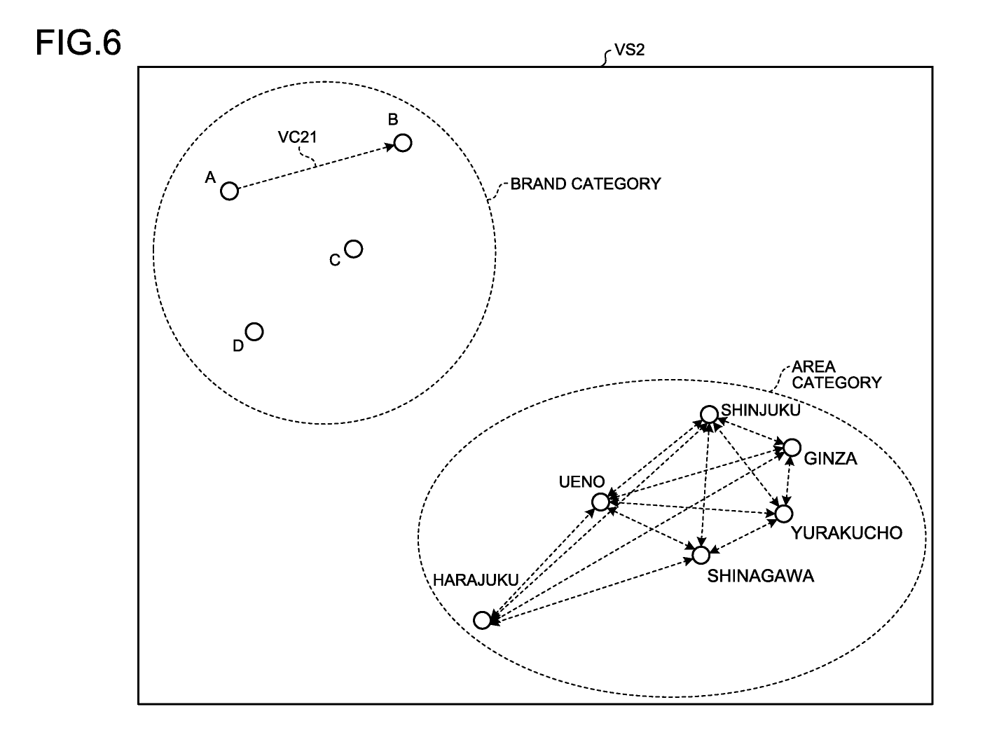

For example, FIG. 6 is a diagram illustrating exemplary distributed representations that the information provision device according to the embodiment specifies. The example illustrated in FIG. 6 represents an exemplary distributed representation space VS2 containing the distributed representations of the contexts “A” to “D” that belong to a category “Brand” and the distributed representations of the contexts “Harajuku”, “Ueno”, “Shinagawa”, “Shinjuku”, “Yurakucho” and “Ginza” that belong to the category “Area”. Note that distributed representations of predetermined contexts are contained in the distributed representation space VS2 in addition to the distributed representations illustrated in FIG. 6.

For example, when the determination subject context “A” and the leading index context “B” are accepted, as illustrated in FIG. 6, the specifying unit 44 calculates a leading content vector VC21 that is from the distributed representation of the determination subject context “A” and that leads to the distributed representation of the leading index context “B”. The specifying unit 44 then calculates all vectors formed by the contexts “Harajuku”, “Ueno”, “Shinagawa”, “Shinjuku”, “Yurakucho” and “Ginza” that belong to the category “Area” and specifies a vector similar to the leading content vector VC21 from among the calculated vectors. For example, when the leading content vector VC21 and the vector that is from the distributed representation of the context “Ueno” and that leads to the distributed representation of the context “Ginza” are similar to each other, the specifying unit 44 provides the distributed representation of the context “Ueno” and the distributed representation of the context “Ginza”.

The specifying unit 44 may specify the end point of the provision vector from among distributed representations of contexts that belong to the same category as the category to which the context serving as the start point of the provision vector belongs. The specifying unit 44 may specify the start point of the provision vector from among distributed representations of contexts that belong to the same category as the category to which the context serving as the end point of the provision vector belongs.

The specifying unit 44 may further specify a distributed representation that is positioned in the vicinity of the provision vector. For example, the specifying unit 44 may specify a predetermined number of distributed representations from among distributed representations positioned in the vicinity of the provision vector and specify an order in which the specified distributed representations are followed such that the impression approximates the distributed representation serving as the end point of the provision vector by stages from the distributed representation serving as the start point of the provision vector. The specifying unit 44 may specify distributed representations positioned in the vicinity of the provision vector such that the inner product of the route in which each distributed representation is followed and the provision vector is within a given range.

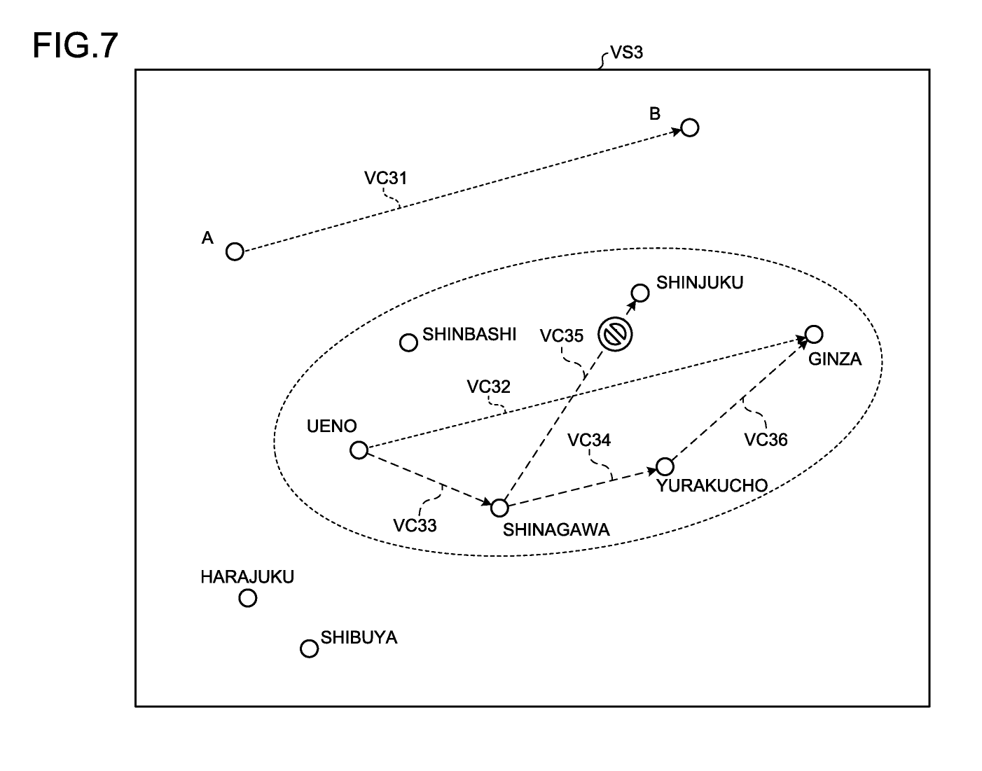

For example, FIG. 7 is a diagram illustrating exemplary distributed representations that the information provision device according to the embodiment specifies and an exemplary order in which each distributed representation is followed. The example illustrated in FIG. 7 represents an exemplary distributed representation space VS3 containing the distributed representations of the contexts “A” and “B” and the distributed representations of the contexts “Harajuku”, “Shibuya”, “Ueno”, “Shinagawa”, “Shinbashi”, “Shinjuku”, “Yurakucho” and “Ginza”. Note that, distributed representations of predetermined contexts are contained in the distributed representation space VS3 in addition to the distributed representations illustrated in FIG. 7.

For example, when the determination subject context “A” and the leading index context “B” are accepted, as illustrated in FIG. 7, the specifying unit 44 calculates a leading content vector VC31 that is from the distributed representation of the determination subject context “A” and that leads to the distributed representation of the leading index context “B”. When the context “Ueno” is accepted as the start point of the provision vector, the specifying unit 44 calculates a multidimensional volume obtained by adding the leading content vector VC31 to the distributed representation of the context “Ueno” and specifies a distributed representation similar to the calculated multidimensional volume, for example, the distributed representation of the context “Ginza”. The specifying unit 44 specifies a provision vector VC32 that is from the distributed representation of the context “Ueno” and that leads to the distributed representation of the context “Ginza”.

The specifying unit 44 specifies distributed representations that are positioned around the provision vector VC32. For example, the specifying unit 44 specifies the distributed representations of the contexts “Ueno”, “Shinagawa”, “Shinbashi”, “Shinjuku”, “Yurakucho” and “Ginza” that are positioned in the dotted oval illustrated in FIG. 7 as the distributed representations positioned around the provision vector VC32. The specifying unit 44 then specifies distributed representations via which the vector from the distributed representation of the context “Ueno” leads to the distributed representation of the context “Ginza” under predetermined conditions.

For example, on choosing the distributed representation of the context “Shinagawa” as the first relay point, the specifying unit 44 specifies a vector VC33 from the context “Ueno” leading to the context “Shinagawa”. The specifying unit 44 then searches for a context of which distributed representation is more close to that of the context “Ginza” than to that of the context “Shinagawa” as the next relay point followed by the distributed representation of the context “Shinagawa”. As a result, in the example illustrated in FIG. 7, the specifying unit 44 specifies the context “Shinjuku” and the context “Yurakucho”.

It is assumed that the user's impressions and the meanings of the contexts are reflected in the distributed representation space VS3. For this reason, it is assumed that a difference occurs in the transition of the meanings between the case where the distributed representations are followed from the context “Ueno” to the context “Shinjuku” via the context “Shinagawa” and the case where the distributed representations are followed from the context “Ueno” to the context “Yurakucho” via the context “Shinagawa”. More specifically, it is assumed that the user's impressions and the meanings of the context “Shinagawa” and the context “Yurakucho” of which distributed representations are projected in the same direction viewed from the provision vector VC32 that is projected onto a two-dimensional plane are similar to each other to some extent. It is however assumed that the user's impressions and the meanings of the context “Shinagawa” and the context “Shinjuku” of which distributed representations are projected in different directions viewed from the provision vector VC32, which is projected onto the two-dimensional plane, deviate from each other to some extent.

As described above, when there is are deviations between the user's impressions and the meanings of the contexts chosen as the relay points, there is a risk that it is not possible to represent proper leading content to the demander. For example, when the demander requests an index to lead the impression of Brand “A” to the impression of Brand “B” by stages, deviation between the impressions and the meanings of the relay points highly likely to not only hinder imaging proper leading content but also hinder properly leading the user's impressions.

The specifying unit 44 thus chooses, as relay points, contexts of which distributed representations are projected in the same direction viewed from the provision vector VC32 that is projected onto the two-dimensional plane. More specifically, the specifying unit 44 calculates a vector VC34 that is from the distributed representation of “Shinagawa” and that leads to the distributed representation of the context “Yurakucho” and a vector VC35 that is from the distributed representation of “Shinagawa” and that leads to the distributed representation of “Shinjuku”. The specifying unit 44 then calculates the inner product of the calculated vector VC34 and the provision vector VC32 and the inner product of the calculated vector VC35 and the provision vector VC32 and chooses a vector whose corresponding inner product is larger than the other one. In other words, the specifying unit 44 chooses a vector whose orientation is more similar to that of the provision vector VC32. For example, in the example illustrated in FIG. 7, the orientation of the vector VC34 is more similar to that of the provision vector VC32 than the orientation of the vector VC35 is. As a result, the specifying unit 44 chooses the vector VC34 and chooses the distributed representation of the context “Yurakucho” serving as the end point of the vector VC34.

Thereafter, the specifying unit 44 specifies a vector VC36 that is from the distributed representation of the context “Yurakucho” and that leads to the distributed representation of the context “Ginza”. As a result, the specifying unit 44 specifies a route that is from the distributed representation of the context “Ueno”, leads to the distributed representation of the context “Shinagawa”, subsequently leads to the distributed representation of the context “Yurakucho”, and then leads to the distributed representation of the context “Ginza”. Accordingly, the specifying unit 44 is able to provide information that makes it possible to easily image the route in which the user's impression is led.

FIG. 2 will be referred back and the description will be continued. The provision unit 45 provides the contexts corresponding to the specified distributed representations. For example, the provision unit provides, to the demander, information representing the context “Ueno” corresponding to the distributed representation serving as the start point of the provision vector VC32 and the context “Ginza” corresponding to the distributed representation serving as the end point of the provision vector VC32, information representing the provision vector VC32, etc. For example, the provision unit 45 provides information representing that “the behavior of leading the impression of Brand “A” to Brand “B” is similar to the behavior of leading the impression of Area “Ueno” to Area “Ginza”” to the demander.

The provision unit 45 may provide contexts corresponding to the distributed representations that are positioned in the vicinity of the provision vector as an index to lead the user's impressing by stages. The provision unit 45 may provide information representing the contexts corresponding to the specified respective distributed representations and an order in which the distributed representations corresponding to the respective contexts are followed. For example, when the specifying unit 44 specifies a route that is from the distributed representation of the context “Ueno”, that reaches the distributed representation of the context “Shinagawa”, subsequently reaches the distributed representation of “Yurakucho”, and then reaches the distributed representation of the context “Ginza”, the provision unit 45 provides information representing that “the behavior of leading the impression from Brand “A” to Brand “B” is similar to the behavior of leading the impression from Area “Ueno” to Area “Shinagawa”, from Area “Shinagawa” to Area “Yurakucho”, and from Area “Yurakucho” to Area “Ginza”” to the demander. The provision unit 45 may provide the contexts chosen as the relay points and values representing the order in which the contexts are followed in association with each other.

4. Exemplary Flow of Process Information Provision Device Executes

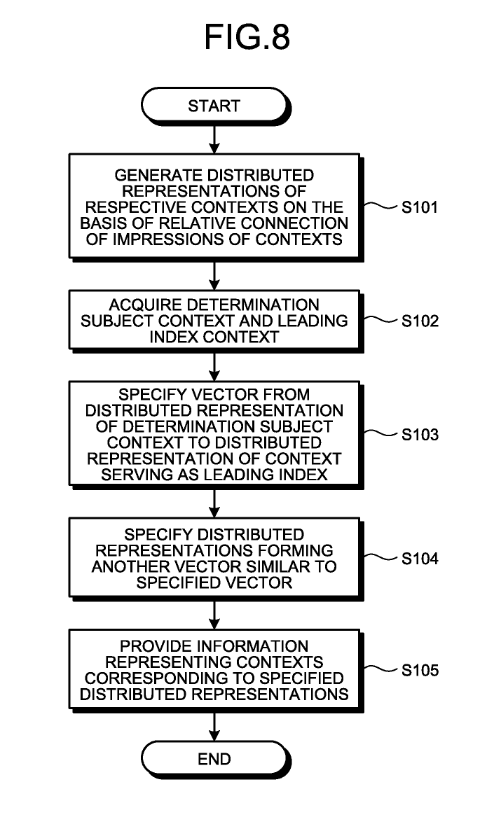

Subsequently, FIG. 8 will be used to describe a flow of a provision process that the information provision device 10 executes. FIG. 8 is a flowchart illustrating an exemplary flow of a provision process that the information provision device according to the embodiment executes. The information provision device 10 is able to execute the process illustrated in FIG. 8 in a predetermined unit and at predetermined timing.

For example, the information provision device 10 generates distributed representations of respective contexts on the basis of a relative connection of impressions of the respective contexts (step S101). The information provision device 10 acquires a determination subject context and a leading index context (step S102). In that case, the information provision device 10 specifies a vector from the determination subject context to the leading index context, that is, a leading content vector (step S103). The information provision device 10 then specifies distributed representations forming another vector similar to the specified leading content vector, that is, a provision vector (step S104). Thereafter, the information provision device 10 provides information representing contexts corresponding to the specified distributed representations (step S105) and ends the process.

5. Modification

The exemplary provision process and the exemplary calculation process performed by the information provision device 10 have been described; however, the embodiments are not limited thereto. Variations of the provision process and the calculation process that are executed by the information provision device 10 will be described.

5-1. About Information to be Provided

In the above-described example, the information provision device 10 provides the contexts of the distributed representations that form the provision vector similar to the leading content vector; however, the embodiments are not limited thereto. For example, the information provision device 10 may estimate which advertisement or news is distributed to enable the impression of the determination subject context to approximate the impression of the leading index context by specifying multiple vectors similar to the leading content vector and analyzing the contexts of the distributed representations forming the specified vectors and may provide the result of the estimation to the demander. In other words, the information provision device 10 may provide any information as long as the information is based on the contexts of the distributed representations forming the provision vector.

The information provision device 10 may determine which event, such as sale of a product or provision of an event, is caused as a given event relating to the determination subject context in addition to various types of distribution information delivered to the user via the network to enable the impression of the determination subject context to be led properly.

The demander may apply any interpretation to the information provided by the information provision device 10. For example, the information provided by the information provision device 10 may be used in any mode as long as the information is used as an index to lead the impression of the determination subject context for, for example, choosing a user targeted by marketing or selecting marketing content.

5-2. About Process in Distributed Representation Space

In the above-described example, the information provision device 10 specifies the provision vector similar to the leading content vector on the basis of the similarity of the vectors in the distributed representation space. The information provision device 10 may determine the similarity between the vectors by using any method to determine similarity between vectors. For example, the information provision device 10 may determine the similarity by using the method that does not take the norm of the vector, such as cosine similarity, into consideration or determine similarity for which the norm is taken into consideration.

5-3. Device Configuration

The information provision device 10 may be realized by a front-end server and a back-end server. In such a case, the acquisition unit 43 and the provision unit 45, which are illustrated in FIG. 2, are arranged in the front-end server and the collecting unit 41, the generation unit 42 and the specifying unit 44 are arranged in the back-end server. Each of the databases 31 to 34 registered in the storage unit 30 may be held by an external storage server.

5-4. Other Aspects

Among the processes described in the above-described embodiments, all or part of a process described as being performed automatically may be performed manually and, inversely, all or part of a process described as being performed manually may be performed automatically according to a known method. In addition to this, it is possible to make any change to the procedures, the specific names, and information containing various types of data and parameters illustrated in the descriptions and drawings except as otherwise specifically provided. For example, the various types of information illustrated in the drawings are not limited to the information illustrated in the drawings.

The components of each of the devices illustrated in the drawings are functional concepts and need not necessarily be configured physically as illustrated in the drawings. In other words, specific modes of distribution and integration of each device are not limited to those illustrated in the drawings, and all or part of the devices may be configured by being dispersed or integrated functionally or physically according to various types of loads and the circumstances in which the devices are used.

It is also possible to combine the above-described embodiments as appropriate as long as no inconsistency is caused in the content of the processes.

5-5. Program

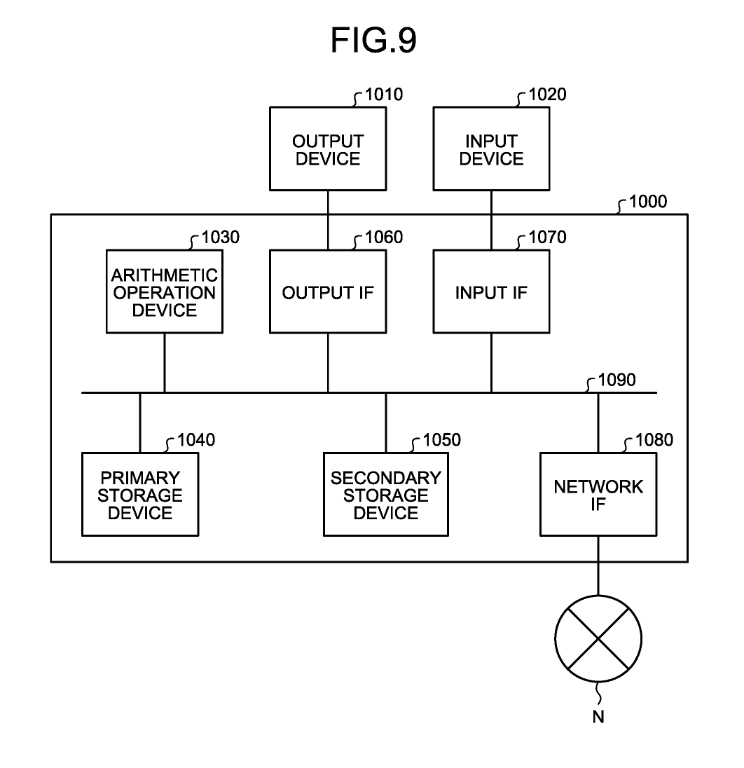

The information provision device 10 according to the above-described embodiment is realized by, for example, a computer 1000 having a configuration like that illustrated in FIG. 9. FIG. 9 is a diagram illustrating an exemplary hardware configuration. The computer 1000 has a mode where the computer 1000 is connected to an output device 1010 and an input device 1020 and an arithmetic operation device 1030, a primary storage device 1040, a secondary storage device 1050, an output interface (IF) 1060, an input IF 1070, and a network IF 1080 are connected via a bus 1090.

The arithmetic operation device 1030 operates according to programs that are stored in the primary storage device 1040 and the secondary storage device 1050 and a program that is read from an input device 102, etc., and executes various types of processes. The primary storage device 1040 is a memory device, such as a RAM, that primarily stores data that is used by the arithmetic operation device 1030 for various types of arithmetic operations. The secondary storage device 1050 is a storage device in which data used by the arithmetic operation device 1030 for various arithmetic operations and various databases are registered, and the secondary storage device 1050 is realized by a read only memory (ROM), a hard disk drive (HDD), a flash memory, or the like.

The output IF 1060 is an interface for transmitting, to the output device 1010, such as a monitor, a printer, or the like, that outputs various types of information to be output. For example, the output IF 1060 is realized by a connector according to standards, such as USB (Universal Serial Bus), DVI (Digital Visual Interface), or HDMI (High Definition Multimedia Interface) (trademark). The input IF 1070 is an interface for receiving information from various input devices 1020, such as a mouse, a keyboard, and a scanner. For example, the input IF 1070 is realized by a USB, or the like.

The input device 1020 may be a device that read information from an optical recording medium, such as a compact disc (CD), a digital versatile disc (DVD) or a phase change rewritable disk (PD), a magneto-optical medium, such as a magneto-optical disk (MO), a tape medium, a magnetic recording medium, or a semiconductor memory. The input device 1020 may be an external storage medium, such as a USB memory.

The network IF 1080 receives data from another device via a network N, transmits the data to the arithmetic operation device 1030, and transmits data that is generated by the arithmetic operation device 1030 to another device via the network N.

The arithmetic operation device 1030 controls the output device 1010 or the input device 1020 via the output IF 1060 and the input IF 1070. For example, the arithmetic operation device 1030 loads programs from the input device 1020 and the secondary storage device 1050 into the primary storage device 1040 and executes the loaded programs.

For example, when the computer 1000 functions as the information provision device 10, the arithmetic operation device 1030 of the computer 1000 realizes the functions of the control unit 40 by executing the program that is loaded into the primary storage device 1040.

6. Effects

As described above, the information provision device 10 acquires a leading index context representing one to which an impression of a determination subject context is led. The information provision device 10 specifies, from distributed representations of respective contexts that are generated on the basis of a relative connection multiple contexts have, other distributed representations having a given connection with a distributed representation of the determination subject context and a distributed representation of the leading index context. As a result, the information provision device 10 is able to provide information representing a behavior of leading the impression of the determination subject context to an impression of the determination index context from another viewpoint, thereby providing an index of distribution information that leads a user's impression of a given subject to a given impression.

The information provision device 10 acquires, as the leading index context, a context to which the impression of the determination subject context is led. The information provision device 10 specifies a vector that is from the distributed representation of the determination subject context and that leads to the distributed representation of the leading index context and specifies, as the other distributed representations, distributed representations forming a provision vector similar to the specified vector. Accordingly, the information provision device 10 is able to properly specify information representing leading content that the demander requests from another viewpoint.

The information provision device 10 specifies the distributed representations forming the provision vector from distributed representations of contexts that belong to a given category. Accordingly, the information provision device 10 is able to properly specify information representing leading content based on the given category that the demander requests.

The information provision device 10 specifies, as the other distributed representations, distributed representations forming a vector that is the provision vector similar to the specified vector and whose start point is a distributed representation of a context that is specified in advance. For example, the information provision device 10 calculates a sum of the distributed representation of the context specified in advance and the specified vector and specifies another distributed representation similar to the calculated sum. The information provision device 10 calculates, as the other distributed representations, distributed representations forming a vector that is the provision vector similar to the specified vector and whose end point is a distributed representation of a context that is specified in advance. For example, the information provision device 10 calculates a multidimensional volume obtained by subtracting the specified vector from the distributed representation of the context that is specified in advance and specifies another distributed representation similar to the calculated multidimensional volume.

As a result of these processes, the information provision device 10 is able to provide information representing a behavior of leading the impression that the demander requests based on a given context that the demander specifies, that is, a persona of the leading behavior. As a result, the information provision device 10 is able to provide information serving as an index of the behavior of leading the impression that the demander requests.

The information provision device 10 specifies, as the another distributed representation, a distributed representation of a context that belong to the same category as that to which the context specified in advance belongs. Accordingly, the information provision device 10 is able to provide an index more easily understandable.

The information provision device 10 further specifies distributed representations that are positioned in the vicinity of the provision vector and provides, as an index to lead the impression of the determination subject context by stages, contexts corresponding to the distributed representations positioned in the vicinity of the provision vector. For example, the information provision device 10 specifies a given number of distributed representations from among the distributed representations positioned in the vicinity of the provision vector such that the impression approximates the distributed representation serving as the end point of the provision vector from the distributed representation serving as the start point of the another vector, and the information provision device 10 specifies an order in which each of the specified distributed representations is followed. The information provision device 10 provides information representing contexts corresponding to the respective specified distributed representations and the order in which the distributed representations corresponding to the respective contexts are followed. Accordingly, the information provision device 10 is able to provide an index to lead the impression of the determination subject context by stages.

The information provision device 10 specifies a given number of distributed representations from among the distributed representations positioned in the vicinity of the provision vector such that an inner product of the route in which each of the distributed representations is followed and the provision vector is within a given range. Accordingly, the information provision device 10 is able to provide a context with less deviation in the impression and meaning as the index to lead the impression of the determination subject context by stages.

The information provision device 10 specifies the another distributed representation from distributed representations of respective contexts that are generated on the basis of a relative connection of impressions of respective contexts a predetermined user has. Accordingly, the information provision device 10 is able to provide an index to lead the user's impression of the determination subject context to the user's impression of a given context.

Some embodiments of the present application have been described in detail according to the drawings; however, the embodiments are exemplified only and it is possible to carry out the invention, starting with the mode described in the disclosure part, in other modes where various modifications and improvements are made on the basis of the knowledge of those skilled in the art.

The above-described “section, module or unit” may be read as “means” or “circuit”. For example, the provision unit 45 may be read as a provision means or a provision circuit.

According to an aspect of the embodiments, it is possible to provide an index of distribution information that leads the user's impression of a given subject to a given impression.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A provision device comprising:
an acquisition unit that acquires a context representing a leading index to lead an impression of a given context;
a specifying unit that specifies, from distributed representations of respective contexts that are generated on the basis of a relative connection multiple contexts have, other distributed representations having a given connection with a distributed representation of the given context and a distributed representation of the context representing the leading index; and
a provision unit that provides contexts corresponding to the other distributed representations that the specifying unit specifies.

2. The provision device according to claim 1, wherein the acquisition unit acquires, as the context representing the leading index, a context to which the impression of the given context is led.

3. The provision device according to claim 1, wherein the specifying unit specifies a vector that is from the distributed representation of the given context and that leads to the distributed representation of the context representing the leading index and specifies, as the other distributed representations, distributed representations forming another vector similar to the specified vector.

4. The provision device according to claim 3, wherein the specifying unit specifies the distributed representations forming the another vector from distributed representations of contexts that belong to a given category.

5. The provision device according to claim 3, wherein the specifying unit specifies, as the other distributed representations, distributed representations forming a vector that is the another vector similar to the specified vector and whose start point is a distributed representation of a context that is specified in advance.

6. The provision device according to claim 5, wherein the specifying unit calculates a sum of the distributed representation of the context specified in advance and the specified vector and specifies another distributed representation similar to the calculated sum.

7. The provision device according to claim 3, wherein the specifying unit specifies, as the other distributed representations, distributed representations forming a vector that is the another vector similar to the specified vector and whose end point is a distributed representation of a context that is specified in advance.

8. The provision device according to claim 7, wherein the specifying unit calculates a multidimensional volume obtained by subtracting the specified vector from the distributed representation of the context that is specified in advance and specifies another distributed representation similar to the calculated multidimensional volume.

9. The provision device according to claim 5, wherein the specifying unit specifies, as the another distributed representation, a distributed representation of a context that belong to the same category as that to which the context specified in advance belongs.

10. The provision device according to claim 3, wherein
the specifying unit further specifies distributed representations that are positioned in the vicinity of the another vector,
the provision unit provides, as an index to lead the impression of the given context by stages, contexts corresponding to the distributed representations positioned in the vicinity of the another vector.

11. The provision device according to claim 10, wherein the specifying unit specifies a given number of distributed representations from among the distributed representations positioned in the vicinity of the another vector such that the impression approximates the distributed representation serving as the end point of the another vector from the distributed representation serving as the start point of the another vector, and the specifying unit specifies an order in which each of the specified distributed representations is followed, and
the provision unit provides information representing contexts corresponding to the respective distributed representations that are specified by the specifying unit and the order in which the distributed representations corresponding to the respective contexts are followed.

12. The provision device according to claim 11, wherein the specifying unit specifies a given number of distributed representations from among the distributed representations positioned in the vicinity of the another vector such that an inner product of the route in which each of the distributed representations is followed and the another vector is within a given range.

13. The provision device according to claim 1, wherein the specifying unit specifies the another distributed representation from distributed representations of respective contexts that are generated on the basis of a relative connection of impressions of respective contexts a predetermined user has.

14. A provision method that is executed by a provision device, the method comprising:
acquiring a context representing a leading index to lead an impression of a given context;
specifying, from distributed representations of respective contexts that are generated on the basis of a relative connection multiple contexts have, other distributed representations having a given connection with a distributed representation of the given context and a distributed representation of the context representing the leading index; and
providing contexts corresponding to the other distributed representations that the specifying unit specifies.

15. A non-transitory computer-readable recording medium having stored a provision program that causes a computer to execute a process comprising:
acquiring a context representing a leading index to lead an impression of a given context;
specifying, from distributed representations of respective contexts that are generated on the basis of a relative connection multiple contexts have, other distributed representations having a given connection with a distributed representation of the given context and a distributed representation of the context representing the leading index; and
providing contexts corresponding to the other distributed representations that the specifying unit specifies.
